(19) United States
(12) Patent Application Publication
(10) Pub. No.: US 2012/0110357 A1
(43) Pub. Date: May 3, 2012

(54) COMMUNICATION APPARATUS, METHOD OF CONTROLLING THE SAME, AND STORAGE MEDIUM

(75) Inventor: Hiroki SHOUNO, Kawasaki-shi (JP)

(73) Assignee: CANON KABUSHIKI KAISHA, Tokyo (JP)

(21) Appl. No.: 13/285,586

(22) Filed: Oct. 31, 2011

(30) Foreign Application Priority Data
Nov. 1, 2010 (JP) 2010-245295

(51) Int. Cl. G06F 1/32; G06F 15/16

(52) U.S. Cl. 713/320

(57) ABSTRACT

A communication apparatus that is capable of communicating with network nodes more properly even when a control unit thereof shifts to a power-saving state. An NIC communicates with the network nodes via a network. The controller communicates with the network nodes via the communication unit. The controller stores node information on a network node that has transmitted data satisfying a predetermined condition, determines whether or not a shift condition for shifting the controller to a power-saving state is satisfied, and notifies the communication unit of the stored node information when it is determined that the shift condition is satisfied. The NIC stores node information notified by the controller, and executes communication processing based on the stored node information when the controller is in the power-saving state.

### BACKGROUND OF THE INVENTION

1. Field of the Invention

The present invention relates to a communication apparatus, a method of controlling the same, and a storage medium, and more particularly to communication control used when the communication apparatus is placed in a power-saving state.

2. Description of the Related Art

In general, in a communication apparatus, such as a multifunction peripheral or a printer, there are used various methods of reducing power consumption.

For example, there has been proposed a communication apparatus that includes a first. CPU, which performs normal processing and a second CPU, which operates when the first. CPU is in a stopped state, and is configured such that the second CPU performs Part of network communications when the first. CPU is in the stopped state (power-saving state) (see Japanese Laid-Open Patent. Publication No. 2006-259906).

In the above-described communication apparatus, the first CPU notifies the second. CPU of information necessary for network communications, such as IP addresses, and the second CPU performs the network communications according to the information.

In general, when the communication apparatus comprises a communication unit and a control unit, the communication unit often uses a CPU lower in performance and a RAM smaller in capacity than a CPU and a RAM used in the control unit, respectively. For example, the CPU of the communication unit is inferior in throughput per unit time, and the RAM thereof is inferior in storage capacity. That is, compared with the CPU and the RAM used in the control unit, which are required to perform a high accuracy of data processing and multi-task processing, the CPU and the RAM used in the communication unit can satisfy target specifications thereof with lower performance and smaller capacity.

However, when hardware resources become insufficient, there arises the following problem:

Let it be assumed, for example, that a large number of network nodes are connected to the same network (e.g. a subnet), and the network nodes intermittently communicate with the communication apparatus. In such a case, when receiving communications from the network nodes, the communication apparatus dynamically updates an ARP (address resolution protocol) table provided therein, that is, ARP entries are registered in the ARP table. However, the number of possible entries in the ARP table depends on the amount of system memory which can be allocated by an operating system.

Therefore, in a case where the capacity of the RAM is small, even when a communication is received from a network node, if the number of registered. ARP entries has already reached an upper limit thereof, it is impossible to register a new ARP entry.

Further, let it be assumed that there are a large number of networks (e.g. subnets) on a LAN, and network nodes connected to the respective networks can communicate with each other via a router. In this case, the network nodes intermittently communicate with the communication apparatus via the router.

Normally, as for communications via the router, routes which destination network nodes should use for communications are registered in a routing table. The number of registered routing tables depends on the amount of memory which can be allocated by the operating system, so that when the capacity of memory is small, the routing table is sometime exhausted.

The above-described problem does not occur when the control unit having a larger RAM capacity stores the ARP cable or the routing table, but it sometimes occurs when the control unit shifts to the power-saving state and the communication unit having a smaller RAM capacity stores the tables. If it is impossible to properly register information concerning network nodes in the ARP table and the routing table, there is a fear that the communication apparatus cannot communicate with the network nodes.

### SUMMARY OF THE INVENTION

The present invention provides a communication apparatus that is capable of communicating with network nodes more properly even when a control unit thereof shifts to a power-saving state, a method of controlling the communication apparatus, and a storage medium.

In a first aspect of the present invention, there is provided a communication apparatus that can communicate with network nodes via a network, including a communication unit configured to communicate with the network nodes via the network, and a control unit configured to communicate with the network nodes via the communication unit, the control unit comprising a first node information storage unit configured to store node information concerning a network node that has transmitted data which is received via the communication unit and satisfies a predetermined condition, a first determination unit configured to determine whether or not a shift condition for shifting the control unit to a power-saving state in which the control unit cannot execute communication processing is satisfied, and a notification unit configured to notify the communication unit of the node information stored in the first node information storage unit when it is determined, by the first determination unit that the shift condition is satisfied, and the communication unit comprising a second node information storage unit configured to store node information notified by the notification unit, and a communication control unit configured to execute communication processing based on the node information stored in the second node information storage unit when the control unit is in the power-saving state.

In a second aspect of the present invention, there is provided a method of controlling a communication apparatus that includes a communication unit configured to communicate with network nodes via a network and a control unit configured to communicate with the network nodes via the communication unit, the method comprising causing the control unit to perform storing node information concerning a network node that has transmitted data which is received via the communication unit and satisfies a predetermined condition, in a first node information storage unit, determining whether or not a shift condition for shifting the control unit to a power-saving state in which the control unit cannot execute communication processing is satisfied, and notifying the communication unit of the node information stored in the first node information storage unit when it is determined by the determining that the shift condition is satisfied, and causing the communication unit to perform storing node information notified by the notifying in a second node information storage unit, and executing communication processing based on the node information stored in the second node information storage unit when the control unit is in the power-saving state.

In a third aspect of the present invention, there is provided a non-transitory computer-readable storage medium storing a program for causing computers to execute a method of controlling a communication apparatus that includes a communication unit configured to communicate with network nodes via a network and a control unit configured to communicate with the network nodes via the communication unit, wherein the method comprises causing the control unit to perform, storing node information concerning a network node that has transmitted data which is received via the communication unit and satisfies a predetermined condition, in a first node information storage unit, determining whether or not a shift condition for shifting the control unit to a power-saving state in which the control unit cannot execute communication processing is satisfied, and notifying the communication unit of the node information stored in the first node information storage unit when it is determined by the determining that the shift condition is satisfied, and causing the communication unit to perform storing node information notified by the notifying in a second node information storage unit, and executing communication processing based on the node information stored in the second node information storage unit when the control unit is in the power-saving state.

According to the present invention, the communication apparatus including the communication unit and the control unit is configured such that when the control unit shifts to the power-saving state, the control unit notifies the communication unit of node information. This enables the communication apparatus to communicate with network nodes more appropriately through communications performed by the communication unit according to the node information, even when the control unit is in the power-saving state.

Further features of the present invention will become apparent from the following description of exemplary embodiments with reference to the attached drawings.

### BRIEF DESCRIPTION OF THE DRAWINGS

FIG. 1 is a view of a network to which is connected an image forming apparatus as a communication apparatus according to an embodiment of the present invention.

FIG. 2 is a block diagram of the image forming apparatus shown in FIG. 1.

FIG. 3 is a sequence diagram useful in explaining operation of the image forming apparatus shown in FIG. 2.

FIG. 4 is a flowchart of a determination process in which an MFP appearing in FIG. 2 determines, by analyzing a received packet, whether or not the packet is of an important communication.

FIG. 5 is a view useful in explaining an example of a management table described with reference to FIG. 4.

### DESCRIPTION OF THE EMBODIMENTS

The present invention will now be described in detail below with reference to the accompanying drawings showing embodiments thereof.

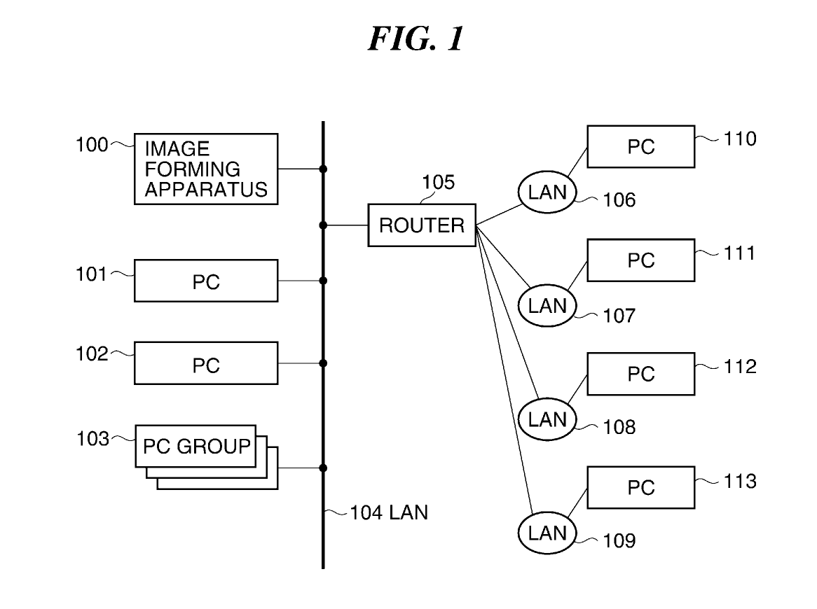

FIG. 1 shows a network to which is connected an image forming apparatus as a communication apparatus according to an embodiment of the present invention.

Referring to FIG. 1, the image forming apparatus 100 is connected to a LAN (local area network) 104 as the network. The image forming apparatus 100 is capable of communicating with external devices, such as PCs (personal computers) 101 and 102, via the LAN 104. As will be described hereinafter, the image forming apparatus 100 shown in FIG. 1 includes an MFP (multi-function peripheral) 200, which is an image processing unit, and an NIC (network interface card) 201, which is a communication unit.

Further, the PCs 101 and 102 and a PC group 103 are connected to the LAN 104. The PCs 101 and 102, and the PC group 103 (hereinafter also referred to as the “network nodes”) transmit print data (job processing request) to the image forming apparatus 100 via the LAN 104. The MFP 200 of the image forming apparatus 100 executes image processing (job processing), such as printing based on the print data Further, the PCs 101 and 102, and the PC group 103 acquire information on a state of the image forming apparatus 100 and a job status thereof from the image forming apparatus 100. The LAN 104 is a network using e.g. Ethernet (registered trademark).

As shown in FIG. 1, a router 105 is connected to the LAN 104. The router 105 connects between the LAN 101 and LANs 106 to 109. In the illustrated example, PCs 110 to 113 (hereinafter also referred to as the “network nodes”) are connected to the LANs 106 to 109, respectively.

The LAN 104 and LANs 106 to 109 are configured as IP (Internet Protocol) networks, which are different from each other. More specifically, the LAN 104 and LANs 106 to 109 are divided as respective subnets. Each of network devices (the PCs and the image forming apparatus 100 in the illustrated example) connected to an associated one of the LAN 104 and LANs 106 to 109 can perform IP communication using the router 105 as a gateway.

As a consequence, each of the PCs 110 to 113 can transmit print data to the image forming apparatus 100 via the router 105, and acquire information on the state of the image forming apparatus 100 and a job status thereof from the image forming apparatus 100.

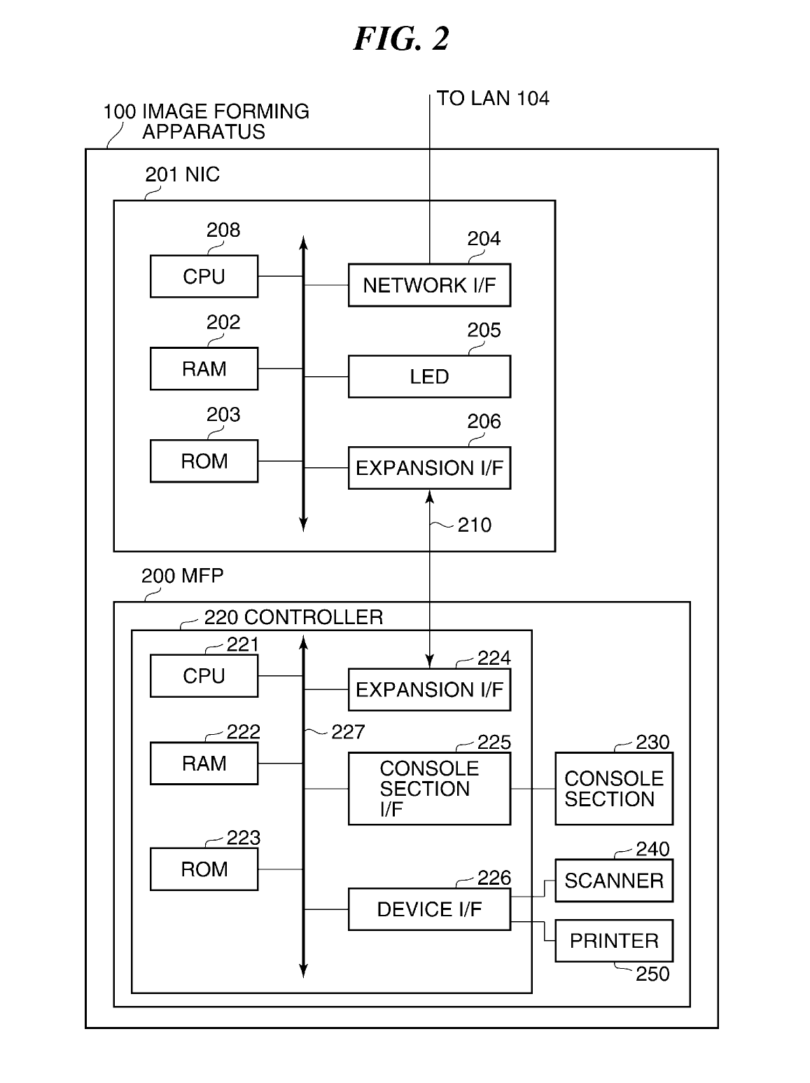

FIG. 2 is a block diagram of the image forming apparatus 100 shown in FIG. 1.

Referring to FIG. 2, the NIC 201, which is the communication unit, is an intelligent network card module, and is a network interface device removably mounted on the MFP 200. The NIC 201 comprises a CPU 208, a RAM 202, a ROM 203, a network Interface (I/F) 204, an LED 205, and an expansion interface (I/F) 206. The CPU 208, the RAM 202, the ROM 203, the network interface 204, the LED 205, and the expansion interface 206 are connected to each other by a system bus 207.

The CPU 208 reads out a control program stored in the ROM 203 and executes various control processes according to the control program. For example, the CPU 208 is connected to the LAN 104 via the network interface 204 connected to the system bus 207, and executes processing for communication with a desired one of the network nodes via the LAN 104 according to a predetermined communication protocol.

For example, in a standby mode (non-deep sleep mode), the CPU 208 receives data, such as print data and a printer control command, from a desired one of the network nodes. Then, the CPU 208 transfers the data to the MFP 200 via the expansion interface 206, whereby print processing is executed by the MFP 200. Further, in a deep sleep mode, referred to hereinafter, the NIC 201 is capable of communicating with the external network nodes in a state where the MFP 200 is in a power-saving state.

The RAM 202 is used as a main memory and a temporary storage area, such as a work area, of the CPU 208. Further, when the CPU 208 operates in the deep sleep mode, an operating system is loaded in the RAM 202, and at the same time the data of protocol programs of a protocol stack is also loaded in the RAM 202 as a subset of the operating system.

The LED 205 is used as a display unit for displaying operating states of the NIC 201. For example, the LED 205 displays a state of electrical connection between de network interface 204 and the LAN 104, and various operating states of the NIC 201 including e.g. a communication mode, with colors or blinking patterns.

The expansion interface 206 connects between the NIC 201 and the MFP 200. The expansion interface 206 is connected to an expansion interface 224 of the MFP 200 via a local cable 210. The expansion interface 206 includes a connector (not shown).

The MID 201 is removably mounted on the MFP 200 by the connector. It is possible to mount the NIC 201 on another MFP having the same configuration as the MFP 200.

The MFP 200 includes a controller 220, an console section 230, a scanner 240, and a printer 250. The controller 220 comprises a CPU 221, a RAM 222, a ROM 223, an expansion interface 224, an console section interface 225, and a device interface 226. The. CPU 221, the RAM 222, the ROM 223, the expansion interface 224, the console section interface 225, and the device interface 226 are connected to each other by a system bus 227.

The CPU 221 reads out a control program stored in the ROM 223 and executes various control processes according to the control program. For example, the CPU 221 generates output image data based on print data transferred from the NIC 201 via the expansion interface 224. Then the CPU 221 outputs the output image data to the printer 250 via the device interface 226.

The RAM 222 serves e.g. as a main memory and a work area of the CPU 221. Further, when an optional RAM is connected to an expansion port (not shown), the memory capacity of the RAM 222 is increased by the optional RAM.

The console section 230 is provided with buttons for performing operations for configuring an operation mode of the MFP 200 and the like, cancelling print data, and so forth. Further, the console section. 230 is provided with a display unit having a liquid crystal panel, an LED (light emitting diode), and the like for displaying operating states of the MFP 200. Further, a communication mode, referred to hereinafter, can be set by the console section 230.

The printer 250 executes printing based on the output image data using an electrophotographic process (laser beam method), an inkjet method, a sublimation method (thermal transfer method) or the like. The scanner 240 reads an image on an original, generates image data, and gives the image data to the controller 220. The printer 250 can also execute printing based on The image data generated by the scanner 240.

The MFP 200 can be set to the standby mode in which predetermined, electric power is consumed and the deep sleep mode in which power consumption is smaller than in the standby mode. In the following, the deep sleep mode will be described as an example of the power-saving state of the MFP 200.

In the deep sleep mode, the MFP 200 stops supply of electric power to units other than specific units, such as the console section 230 and the expansion interface 224, whereby power consumption by the MFP 200 is suppressed. More specifically, in the standby mode, the MFP 200 is capable of executing job processing, such as printing, whereas in the deep sleep mode, the MFP 200 is incapable of executing job processing.

Further, in the deep sleep mode, the NIC 201 is energized. This enables the NIC 201 to communicate with the external network nodes, as described above. Further, the deep sleep mode includes a mode in which the supply of electric power to the RAM 222 is continued, and a mode in which the supply of electric power to the RAM 222 is also stopped. The latter is called a hibernation mode, in which data stored in the RAM 222 is copied into an HDD (hard disk drive) (not shown), for stopping the supply of electric power to the RAM 222.

As described above, in the deep sleep mode, power consumption by the image forming apparatus 100 becomes very low. On the other hand, when the image forming apparatus 100 is in the deep sleep mode, the energization of a drum, a fixing unit, the CPU 221 and the HOD provided in the image forming apparatus 100 is stopped. Therefore, when a main function, such as printing or image processing, of the image forming apparatus 100 is to be executed, it is necessary to shift the image forming apparatus 100 from the deep sleep mode to the standby mode.

Further, the NIC 201 is equipped with a function called a proxy response, which is responsive to a predetermined network packet while the MFP 200 in the deep sleep mode.

As described hereinabove, the CPU 221 is stopped in the deep sleep mode, and hence the MFP 200 cannot respond to received packets. Therefore, unless the NIC 201 is equipped with the proxy response function, when the NIC 201 receives a packet addressed to the image forming apparatus 100, the MFP 200 is caused to return from the deep sleep mode to the standby mode.

As a consequence, in a case where there is a network node which frequently communicates with the image forming apparatus 100, or in a case where there are a large number of network nodes which though not frequently, communicates with the image forming apparatus 100, the MFP 200 frequently returns from the deep sleep mode to the standby mode. This makes it impossible to effectively place the image forming apparatus 100 in the power-saving state.

A technique for solving such a problem is the above-described proxy response function. The proxy response function is equipped in the NIC 201, for responding to specific packets. By using the proxy response function, it is possible to respond to ones having specific patterns, out of network packets which have been received by the NIC 201 from the LAN 104, without causing the MFP 200 to return from the deep sleep mode. This makes it possible to effectively maintain the power-saving state of the image forming apparatus 100.

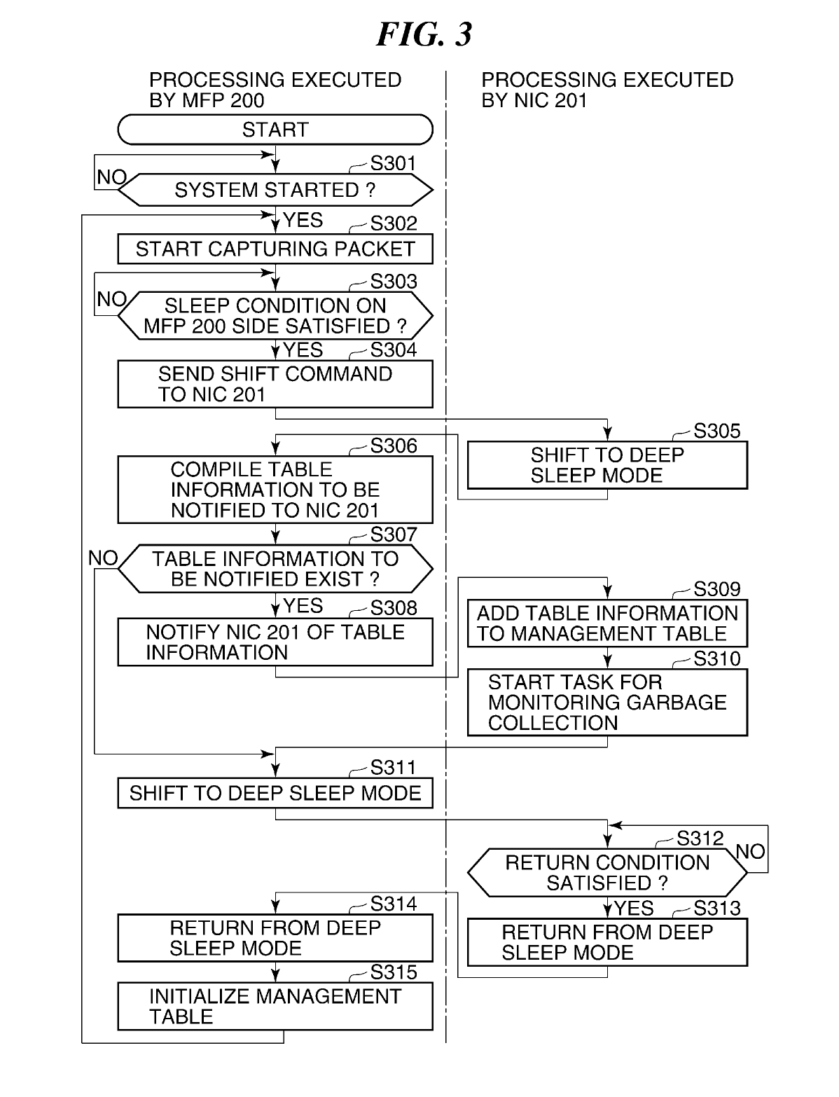

FIG. 3 is a sequence diagram useful in explaining the operation of the image forming apparatus 100 shown in FIG. 2.

When the power of the image forming apparatus 100 is turned on, processing shown in FIG. 3 is started. First, the CPU 221 monitors whether or not the start of the system of the MFP 200 and die NIC 201 has been completed (step S301). If the start of the system has not been completed (NO to the step S301), the CPU 221 awaits the start of the system.

On the other hand, if the start of the system has been completed (YES to the step S301), the CPU 221 captures a packet received by the NIC 201 (step S302). This causes the CPU 221 to start compiling of information on network nodes with which the image forming apparatus 100 performs important communications, out of communications addressed to the image forming apparatus 100. For example, the CPU 221 executes a program using a socket API (application programming interface) called a packet socket, which makes it possible to acquire packet information at the Ethernet (registered trademark) frame level.

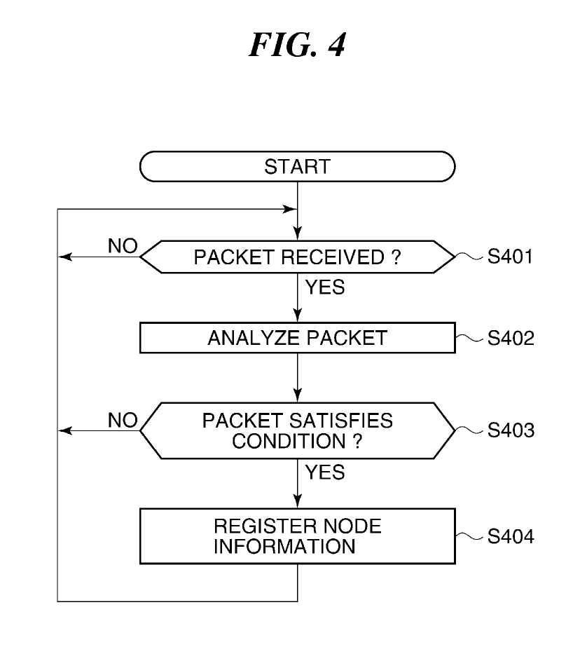

FIG. 4 is a flowchart of a determination process in which the MFP 200 shown in FIG. 2 determines, by analyzing a received packet, whether or not the communication using the packet is important.

Now, the determination process will be described with reference to FIGS. 2 and 4. Here, it is assumed that the operation of the image forming apparatus 100 is always performed when the image forming apparatus 100 is in the standby mode. That is, the operation is executed in parallel with various processes carried out by the image forming apparatus 100.

The CPU 221 monitors whether or not the NIC 201 has received a packet (step S401). If no packet has been received (NC to the step S401), the CPU 221 awaits reception of a packet. On the other hand, if a packet has been received (YES to the step S401), the CPU 221 analyzes the packet (step S402). This analysis is performed so as to determine whether or not the packet includes important contents for the image forming apparatus 100.

For example, the CPU 221 compares the contents of the received packet and predetermined conditions (values), and determines based on the result of the comparison whether or not the received packet is important.

The term “important communication”, that is, “important packet” is intended to mean a packet that satisfies one of the following conditions:

(1) A session start request to TCP (transfer control protocol) Port 515 (TCP SIN request)

(2) A session start request to TCP Port 9100 (TCP SIN request)

(3) Data transmitted to a specific UDP (user datagram protocol) port

The above-described condition (3) implies transmission of data using a protocol peculiar to the image forming apparatus 100. The PCs on the LANs can acquire and set the device status and the job status of the image forming apparatus 100 using the UDP.

The above-described three conditions mean that the important communications are requests made by PCs to the image forming apparatus 100, for starting reception of print data, for sending device information, and for setting the device (the image forming apparatus 100). If any of these important communications cannot be made, the incapability has a large adverse effect on the sender of data. Therefore, also when the image forming apparatus 100 is in the deep sleep mode, it is required that the above-described important communications can be normally processed.

In the illustrated example, no such a protocol or data on a protocol as will not have a large adverse effect on the sender is included in the three conditions. However, the conditions for the important communications are not limited to the above-described three conditions, but actually, the conditions can be changed according the functions and performance of the image forming apparatus, a network infrastructure, and communication techniques. That is, other conditions may be additionally included in the above-described three conditions.

In the present embodiment, in FIG. 1, the PCs mean the PCs 101 and 102, and the PC group 103, and the network nodes also mean the PCs 101 and 102, and the PC group 103. The PCs 101 and 102, and the PC group 103 are connected to the LAN 104, and exist on the same network as the image forming apparatus 100 does. Therefore, when the image forming apparatus 100 receives a packet from one of the PCs 101 and. 102, and the PC group 103, the CPU 221 updates an APR (address resolution protocol) table in order to dynamically update the ARP entries.

The CPU 221 determines whether or not the received packet satisfies one of the above-described conditions (communication conditions defined in advance) (step S403). If the received packet does not satisfy any of the above-described conditions (NO to the step S403), the CPU 221 returns to the step S401 to continue the process.

On the other hand, if the received packet satisfies one of the above-described conditions (YES to the step S403), the CPU 221 registers node information on a network node having transmitted the received packet, in a management table managed by the CPU 221, as information on a network node that performs important communications (important node information) (step S404). This management table is stored e.g. in the RAM 222.

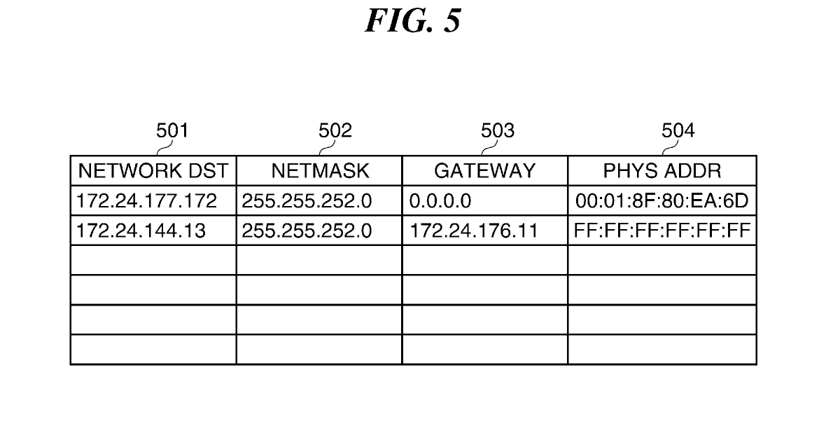

FIG. 5 is a view useful in explaining an example of the management table described with reference to FIG. 4.

The management table illustrated in FIG. 5 is updated by the CPU 221. This management table is used for registering identification information on network nodes having performed important communications. As described hereinafter, when the image forming apparatus 100 is shifted from the standby mode to the deep sleep mode, the CPU 221 causes the NIC 201 to take over the management table.

In the NIC 201, the CPU 208 registers the management table e.g. in the protocol stack loaded in the RAM 202 as mentioned above. In the illustrated. example, the management table is an ARP table

Referring to FIG. 5, the management table comprises a column of network DST (destination) (Network DST) 501, a column of netmask (Netmask) 502, a column of gateway information. (Gateway) 503, and a column of physical address (Phys Addr) 504. The network DST 501 indicates an IP address of a network node as a communication destination. The gateway 503 indicates a gateway address assigned to the network node. The physical address 504 indicates a MAC (media access control) address of the network node.

Among the above, information items necessary for each ARP entry are the network. DST 501 and the physical address 504. Therefore, based on the packet analyzed in the above-mentioned step S402, the CPU 221 registers the network DST 501 and physical address 504 of the network node having transmitted the packet, in the management table.

Although the netmask 502 and the gateway 503 are not information items necessary for each ARP entry, they become necessary for registration in a routing table, described hereinafter.

In the present embodiment, upon reception of a packet from one of the PCs 101 and 102, and the PC group 103, the management table is updated, as described above.

As to the router 105 connected to the other networks, only information items concerning a port connected to the LAN 104 are registered in the management table. More specifically, the information items of MAC addresses and IP address of ports connected to the other networks are not registered in the management table. Similarly, information items concerning network nodes connected to the other LANs than the LAN 104 are not registered in the management table, either.

Referring again to the FIG. 3 flowchart, the CPU 221 determines whether or not a shift condition for shifting the image forming apparatus 100 to the deep sleep mode (sleep condition) is satisfied. (step S203). If it is determined that the sleep condition is not satisfied (NO to the step S303), the CPU 221 waits for the sleep condition to be satisfied.

On the other hand, if it is determined that the sleep condition is satisfied (YES to the step S303), the CPU 221 starts a process for shifting to the deep sleep mode. First, the CPU 221 transmits a sleep mode shift command to the NIC 201 (step S304). When the NIC 201 receives the sleep mode shift command, the CPU 208 starts a process for shifting to the deep sleep mode (shift-to-sleep mode process) (step S305), thereby switching from the standby mode to the deep sleep mode.

When the image forming apparatus 100, i.e. the MFP 200 is operating in the standby mode, the NIC 201 operates as a network interface. More specifically, communications with the outside are never carried out only by the NIC 201 but are always carried out also via applications and a protocol stack operating on the CPU 221. On the other hand, after the image forming apparatus 100 shifts to the deep sleep mode, the NIC 201 alone communicates with the external network nodes.

In the shift-to-sleep mode process, the CPU 208 starts a predetermined application to shift the image forming apparatus 100 to the deep sleep mode. When the start of the deep sleep mode is normally completed, the CPU 208 transmits a sleep mode completion notification to the MFP 200.

When the MFP 200 receives the sleep mode completion notification, the CPU 221 compiles table information to be notified to the NIC 201 (step S306). That is, the CPU 221 compiles node information recorded in the FIG. 5 management table as table information.

As described with reference to FIGS. 4 and 5, the term “table information” is intended to mean information on network nodes which are required to be preferentially assigned to the management table managed by she NIC 201, when the NIC 201 operates in the deep sleep mode.

Then, the CPU 221 determines based on the result of compilation whether or not there is table information to be notified to the NIC 201 (step S307). If it is determined that there is table information to be notified to the NIC 201 (YES to the step S307), the CPU 221 notifies the NIC 201 of the table information (step S308).

When the NIC 201 receives the table information, the CPU 208 assigns the table information to the management table managed by the protocol stack (step S309). Here, the management table in which the table information should be registered is an ARP table, as mentioned hereinbefore. Therefore, the CPU 208 registers each network DST 501 and physical address 504 of the notified table information as an ARP entry in the ARP table.

Then, the CPU 208 starts software (task) for monitoring a garbage collection (step S310). Here, the term “garbage collection” is intended to mean an operation in which when an ARP entry registered in the ARP table is not used for a predetermined time period, the ARP entry is deleted by the protocol stack itself.

The above-mentioned software (task) always monitors the ARP table, and when she table information registered in the step S309 is deleted by the garbage collection, registers the table information again. As a consequence, even when a table information item notified from the MFP 200 is deleted by the garbage collection, it is possible to instantly restore the table information item.

Next, the CPU 221 executes shifting of the MFP 200 to the deep sleep mode (step S311). When the shifting is completed, the shift of the image forming apparatus 100 to the deep sleep mode is completed.

In the step S307, if there is no table information to be notified to the NIC 201 (NC) to the step S307), the CPU 221 directly proceeds to the step S311.

When the image forming apparatus 100 has shifted to the deep sleep mode, in the NIC 201, the CPU 208 monitors whether or not return conditions for returning the image forming apparatus 100 from the deep sleep mode to the standby mode have been satisfied (step S312).

To perform shifting of the image forming apparatus 100 from the deep sleep mode to the standby mode, predetermined conditions are defined in advance. When the image forming apparatus 100 satisfies one of the conditions (referred to as the “return conditions”), electric power starts to be supplied to blocks which have been inhibited from being energized. This causes the image forming apparatus 100 to return to a state in which all the functions of the image forming apparatus 100 can be used, that is, the standby mode.

In general, the following two conditions are defined as the return conditions.

(1) Any of the buttons of the console section 230 of the image forming apparatus 100 is pressed.

(2) The NIC 201 of the image forming apparatus 100 receives any of predetermined specific network packets.

To determine whether either of the two conditions is satisfied, even when the image forming apparatus 100 is in the deep sleep mode, the console section 230 and the NIC 201 are energized, as described hereinabove. Sensors or the like monitor whether or not any of the buttons of the console section 230 has been pressed and whether or not any of the specific network packets has been received.

In general, the above-mentioned Predetermined specific network packet can include, for example, the following packets:

(1) A packet transmitted to the image forming apparatus 100 (packet having a destination-MAC address set to the image forming apparatus 100)

(2) A sleep return packet

(3) A broadcast packet or a multicast packet of a specific protocol

Here, the term “sleep return packet” is intended to mean a packet having a specific pattern for returning the image forming apparatus 100 from the deep sleep mode. For example, a magic packet or a packet having a specific pattern peculiar to a vender or a manufacturer is used as the sleep return packet.

The term “a broadcast packet or a multicast packet of a specific protocol” is intended to mean a packet including a protocol and data used when another network node searches the image forming apparatus 100 on the same network.

When the packet received by the NIC 201 is one of the above-mentioned packets, the image forming apparatus 100 returns from the deep sleep mode to the standby mode. In general, a pattern of a packet and the packet itself for returning the image forming apparatus 100 from the deep sleep mode to the standby mode are collectively called a WOL (wake on LAN) packet.

Further, as described above, the return of the image forming apparatus 100 from the deep sleep mode to the standby mode upon reception of the WOL packet is referred to as WOL (wake on LAN).

In the WOL, the reception of the WOL packet, for example, is used as a return condition from the deep sleep mode. Normally, in the WOL, when the network node receives a packet including standardized data, the image forming apparatus 100 returns from the deep sleep mode.

In the present embodiment, when a packet satisfying a predetermined peculiar packet data pattern is received, the WOL is performed.

For example, in a case where print data is received, the image forming apparatus 100 is required to return from the deep sleep mode. To this end, in the present embodiment, it is preconditioned that the image forming apparatus 100 returns from the deep sleep mode in response to a TCP/IP SYN request or the like.

The CPU 208 monitors whether or not the above-described WOL packet has been received via the LAN 104, while carrying out communication processing in the deep sleep mode.

During the monitoring, the NIC 201 receives various communications, i.e. packets from the network nodes. Further, in responding to the received packets, the CPU 208 refers to the ARP table and the routing table registered in the protocol stack thereof, and acquires necessary information from The tables. Based on this, the NIC 201 generates response packets to the received packets, and sends The same back to the network nodes.

As described hereinabove, the table information compiled by the MFP 200 is registered in the ARP table (i.e. management table) of the NIC 201. This makes it possible to establish communication with important network nodes with a high probability, even when the RAM 202 has a small memory capacity for storing the protocol stack in the deep sleep mode.

If the return condition for returning the image forming apparatus 100 from the deep sleep mode to the standby mode is not satisfied (NO to the step S312), the CPU 208 performs communication processing in the deep sleep mode, as described hereinabove. On the other hand, if the return condition is satisfied, that is, when the WOL packet is received (YES to the step S312), the CPU 208 carries out a return process for returning from the deep sleep mode to the standby mode (step S313). At this time, the CPU 208 instructs an electric power control unit. (not shown in FIG. 2) to energize the CPU 221 and so forth, thereby causing the MFP 200 to return from the deep sleep mode to the standby mode.

The CPU 208 stops a task operating for the deep sleep mode, and performs operations corresponding to the functions of the Ethernet (registered trademark) network card. Then, the CPU 208 starts the standby mode.

Next, the MFP 200 as well, performs the return process for returning from the deep sleep mode to the standby mode. In the present embodiment, the CPU 221 returns the operating system and applications installed, in the image forming apparatus 100 from the deep sleep mode to the standby mode (step S314). This causes the image forming apparatus 100 to resume operations in the standby mode.

Next, the CPU 221 initializes the management table shown in FIG. 5 (step S315). Then, the CPU 221 returns to the step S302 to execute the process for acquiring packets, i,e, compiling node information.

As described heretofore, in the first embodiment, when the image forming apparatus 100 shifts to the deep sleep mode, information necessary for network communications is taken over from the CPU 221 of the MFP 200 to the CPU 208 of the NIC 201. This enables the image forming apparatus 100 to reliably communicate with the network nodes even when the image forming apparatus 100 is in the power-saving state e.g. in the deep sleep mode.

Next, a communication apparatus according to a second embodiment of the present invention will be described. Here, it is assumed that the contents of the routing table are shared between the MFP 200 and the NIC 201. Further, in the following, a description will be given of only different points from the fir at embodiment, and detailed description of points common to those of the first embodiment is omitted.

In the second embodiment, not only the PCs connected to the LAN 104 but also the PCs connected to the LAN 104 via the router 105 are taken into account. In the following description as well, PCs are sometimes called network nodes.

As described heretofore, the CPU 221 records information on network nodes which perform important communications, in the management table. This management table includes not only the ARP table but also the routing table. Information items necessary for each entry of the routing table are the network DST 501, the netmask 502, and the gateway 503, shown in FIG, 5.

Therefore, the CPU 221 registers the network DST 501, the netmask 502, and the gateway 503 in the management table based on the packet analyzed in the step S402 in FIG. 4 In this case, the physical address 504 in FIG. 5 is not information necessary for an entry of the routing table, but it is necessary for registration of the ARP table described in the first embodiment.

As described hereinabove, although in the step S309, the CPU 208 assigns the table information to the protocol stack, in the present embodiment, the table in which the table information is to registered is the routing table. Therefore, the CPU 208 registers the network DST 501, the netmask 502, and the gateway 503, out of the table information notified from the MFP 200.

As described above, in the step S312, the CPU 208 monitors whether or not the WOL packet has been received via the LAN 104. During the monitoring, when responding to the received packets, the CPU 208 refers to the ARP table and the routing table registered in the protocol stack, to thereby generate response packets.

As described above, in the second embodiment, even when packets are received via the router 105, information necessary for network communication is taken over from the CPU 221 to the CPU 208, and hence it is possible for the image forming apparatus 100 to reliably communicate with network nodes having transmitted the packets even when the image forming apparatus 100 is in the power-saving state e.g. in the deep sleep mode.

As described heretofore, according to the above-described embodiments, even in a case where the image forming apparatus shifts to the deep sleep mode, and the communication unit (NIC 201) is operating in a proxy response mode, a PC (network node) that desires to communicate with the image forming apparatus can reliably perform the desired communication. More specifically, since identification information of a network node that performs important communications is statically registered in the ARP table or the routing table, it is possible to reliably communicate with the network node that performs important communications without increasing the memory capacity.

Although in the above-described embodiments, the communication apparatus is described by taking the image forming apparatus as an example, the communication apparatus may be a host computer which performs job processing, such as information processing, in response to a job processing request from a terminal device, such as a network node. Whatever the case may be, insofar as a device or apparatus is disposed on a network and performs job processing in response to a job processing request from a terminal device, such as a network node, the present invention can be applied to the device or apparatus.

As is apparent from the above description, referring to FIG. 2, the CPU 221 and the RAM 222 function as a first node information storage unit, and the CPU 221 functions as a first determination unit. Further, the CPU 221 and the expansion interface 224 function as a notification unit. Furthermore, the CPU 208 and the RAM 202 function as a second node information storage unit, and the CPU 208 and the network interface 204 function as a communication control unit. In addition, the CPU 208 functions as an assignment unit, a second determination unit, and a first return unit, and the CPU 221 functions as a second return unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

For example, the functions of the above-described embodiments can be realized as a control method by causing a computer provided in an image forming apparatus to execute the control method. In this case, it is possible to cause the computer provided in the image forming' apparatus to execute a control program having the functions of the above-described embodiments.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a storage medium of various types serving as the memory device (e.g., computer-readable medium).

This application claims priority from Japanese Patent Application No. 2010-245295 filed Nov. 1, 2010, which is hereby incorporated by reference herein in its entirety.

What is claimed is:

1. A communication apparatus that can communicate with network nodes via a network, including:
a communication unit configured to communicate with the network nodes via the network; and
a control unit configured to communicate with the network nodes via said communication unit, said control unit comprising:
a first node information storage unit configured to store node information concerning a network node that has transmitted data which is received via said communication unit and satisfies a predetermined condition;
a first determination unit configured to determine whether or not a shift condition for shifting said control unit to a power-saving state in which said control unit cannot execute communication processing is satisfied; and
a notification unit configured to notify said communication unit of the node information stored in said first node information storage unit when it is determined by said first determination unit that the shift condition is satisfied, and
said communication unit comprising:
a second node information storage unit configured to store node information notified by said notification unit; and
a communication control unit configured no execute communication processing based on the node information stored in said second node information storage unit when said control unit is in the power-saving state.

2. The communication apparatus according to claim 1, wherein said communication unit further comprises a restoration unit configured to restore the node information notified by said notification unit in said second node information storage unit when the node information notified by said notification unit has been deleted from said second node information storage unit.

3. The communication apparatus according to claim 1, wherein the communication processing based on the node information stored in said second node information storage unit is started when the communication apparatus is in the power-saving state.

4. The communication apparatus according to claim 1, wherein said communication unit further comprises:
a second determination unit configured to determine whether or not a return condition for causing the communication apparatus to return from the power-saving state is satisfied; and
a return unit configured to cause said control unit to return from the power-saving state when it is determined by said second determination unit that the return condition is satisfied.

5. The communication apparatus according to clam 4, wherein the return condition for causing the communication apparatus to return from the power-saving state is that said communication unit receives specific information via the network

6. The communication apparatus according to claim 5, wherein the specific information is a WOL packet.

7. The communication apparatus according to claim 5, wherein the specific information is a job processing request.

8. A method of controlling a communication apparatus that includes a communication unit configured to communicate with network nodes via a network and a control unit configured to communicate with the network nodes via the communication unit,
the method comprising:
causing the control unit to perform:
storing node information concerning a network node that has transmitted data which is received via the communication unit and satisfies a predetermined condition, in a first node information storage unit,
determining whether or not a shift condition for shifting the control unit to a power-saving state in which the control unit cannot execute communication processing is satisfied, and
notifying the communication unit of the node information stored in the first node information storage unit when it is determined by said determining that the shift condition is satisfied; and
causing the communication unit to perform:
storing node information notified by said notifying, in a second node information storage unit, and
executing communication processing based on the node information stored in the second node information storage unit when the control unit is in the power-saving state.

9. A non-transitory computer-readable storage medium storing a program for causing computers to execute a method of controlling a communication apparatus that includes a communication unit configured to communicate with network nodes via a network and a control unit configured to communicate with the network nodes via the communication unit,
wherein the method comprises:
causing the control unit to perform:
storing node information concerning a network node that has transmitted data which is received via the communication unit and satisfies a predetermined condition, in a first node information storage unit,
determining whether or not a shift condition for shifting the control unit to a power-saving state in which the control unit cannot execute communication processing is satisfied, and
notifying the communication unit of the node information stored in the first node information storage unit when it is determined by said determining that the shift condition is satisfied; and
causing the communication unit to perform:
storing node information notified by said notifying, in a second node information storage unit, and
executing communication processing based on the node information stored in the second node information storage unit when the control unit is in the power-saving state.
